(19) United States
(12) Patent Application Publication
(10) Pub. No.: US 2026/0269146 A1
(43) Pub. Date: Sep. 10, 2026

(54) ELECTROCHEMICAL CAPACITOR

(71) Applicant: Panasonic Intellectual Property Management Co., Ltd., Osaka (JP)

(72) Inventors: YUTA NISHIMORI, Osaka (JP); YUSUKE OGIHARA, Osaka (JP); CHIHO NOBUMORI, Hyogo (JP); TATSUYA NAKAMURA, Osaka (JP); TAKESHI MINAMIURA, Osaka (JP); KENICHI EZAKI, Osaka (JP)

(21) Appl. No.: 19/166,237

(22) PCT Filed: Feb. 19, 2024
(86) PCT No.: PCT/JP2024/005847

§ 371 Date: Sep. 17, 2025

(30) Foreign Application Priority Data
Mar. 24, 2023 (JP) 2023-048465

(51) Int. Cl. H01G 11/62; H01G 11/24; H01G 11/38

(52) U.S. Cl. CPC H01G 11/62; H01G 11/24; H01G 11/38

(57) ABSTRACT

An electrochemical capacitor including: a first electrode containing a first active material; a second electrode containing a second active material; and an electrolytic solution, wherein the electrolytic solution contains an ionic liquid, and when a surface of the first electrode is quantitatively analyzed based on relative sensitivity factor by using X-ray photoelectron spectroscopy (XPS), an atomic ratio R_{F} of an element F derived from the ionic liquid to an element C is 10% or more.

### TECHNICAL FIELD

The present invention relates to an electrochemical capacitor.

### BACKGROUND ART

As demand for ICT application such as personal computers and smartphones, in-vehicle application, and power storage application increases, electrochemical devices represented by the capacitor are required to have a higher capacity.

Graphene has a theoretical specific surface area of about 2600 m²/g and has electric conductivity, and thus is promising as an electrode material for a capacitor.

PTL 1 proposes a graphene sheet film in which two or more graphene sheets are stacked in parallel via carbon nanotubes, and the graphene sheet stacks are electrically and mechanically connected to each other in a three-dimensional manner by carbon nanotubes. It has been reported that the film is used as an electrode to obtain a capacity of 290.6 F/g.

### CITATION LIST

### Patent Literature

PTL 1: International Publication No. WO 2012/073998

### SUMMARY OF THE INVENTION

One aspect of the present invention relates to an electrochemical capacitor. The electrochemical capacitor includes: a first electrode containing a first active material; a second electrode containing a second active material; and an electrolytic solution. The electrolytic solution contains an ionic liquid, and when the surface of the first electrode is quantitatively analyzed based on relative sensitivity factor by using X-ray photoelectron spectroscopy (XPS), the atomic ratio R_{F} of an element F derived from the ionic liquid to an element C is 10% or more.

According to the present disclosure, an electrochemical capacitor having a high energy density can be realized.

### BRIEF DESCRIPTION OF THE DRAWINGS

FIG. 1 is a diagram illustrating partially cutaway perspective view of an electrochemical capacitor according to an exemplary embodiment of the present disclosure.

FIG. 2 is a graph showing the change in single electrode capacity C₁ with respect to applied voltage V₁ for the capacitors of Example 1 and Comparative Example 1.

FIG. 3 shows F Is spectra of the surface of a negative electrode in XPS analysis for the capacitors of Example 1 and Comparative Example 1.

### DESCRIPTION OF EMBODIMENT

As compared with a lithium ion battery, the capacitor described in PTL 1 can be rapidly charged and discharged and has a high power density, but still has a low energy density and has limited applications. In order to expand the application of electrochemical capacitors, the energy density thereof is required to further increase.

The higher the operating voltage of a capacitor, the higher the energy density is obtained. Therefore, a combination of an electrolytic solution and an electrode material that operates at a high voltage has been searched.

Hereinafter, the electrochemical capacitor includes capacitors having various electric storage mechanisms. The electrochemical capacitor means, for example, an electric storage device at least partially having an electric storage mechanism such as an electric double layer capacitor or a lithium ion capacitor. The electric storage device or the electrochemical capacitor includes a pair of capacitor electrodes and an electrolytic solution. The electrode contains an active material.

For example, the active material exhibits a capacity by doping and dedoping ions. The doping of ions to the active material is a concept including adsorption of ions to the active material, occlusion of ions by the active material, chemical interaction between the active material and ions, and the like. The dedoping of ions from the active material is a concept including desorption of ions from the active material, release of ions from the active material, release of chemical interaction between the active material and ions, and the like. Here, the doping of ions to the active material mainly refers to adsorption of ions to the active material, and the dedoping of ions from the active material mainly refers to desorption of ions from the active material. When ions are adsorbed to the active material, an electric double layer is formed to exhibit a capacity. That is, the capacitor electrode mainly means a polarizable electrode, but may be an electrode that has properties of a polarizable electrode and has its capacity contributed by a Faraday reaction.

An electrochemical capacitor according to an exemplary embodiment of the present disclosure includes: a first electrode containing a first active material; a second electrode containing a second active material; and an electrolytic solution. A separator is usually interposed between the first electrode and the second electrode. The electrolytic solution contains an ionic liquid. Hereinafter, the electrochemical capacitor according to the present disclosure may be simply referred to as “capacitor”.

In the electrochemical capacitor of the present disclosure, according to an exemplary embodiment, cations or anions constituting the ionic liquid are adsorbed to the first active material or the second active material so that an electric double layer is formed to exhibit a capacity. In addition, when a high voltage equal to or higher than a threshold value is applied, a reduction reaction of the cation constituting the ionic liquid or an oxidation reaction of the anion occurs so that a capacity is also developed through charge transfer between the active material and the cation or the anion by the oxidation-reduction reaction.

A voltage of 4.0 V or more can be applied between the first electrode and the second electrode. In this case, a capacity is generated through an oxidation-reduction reaction, and a capacitor having a high capacity and a high energy density can be realized.

One of the first electrode and the second electrode is the positive electrode of the capacitor, and the other is the negative electrode. In the following description, the first electrode is referred to as negative electrode, and the second electrode is referred to as positive electrode. That is, it is assumed in use that the first electrode is applied with a potential lower than that of the second electrode. The first electrode and the second electrode may be the same electrode or different electrodes.

When the surface of the first electrode is quantitatively analyzed based on relative sensitivity factor by using X-ray photoelectron spectroscopy (XPS), the atomic ratio R_{F} of an element F derived from the ionic liquid to an element C is 10% or more. In this case, the capacitor can realize a high capacity and a high energy density. The reason for this is considered as follows in the present findings of the inventors. However, the present invention is not limited thereto.

Cations or anions contained in the ionic liquid are reduced or oxidized when applied with a high voltage, and reaction products of the reduction reaction or the oxidation reaction can be generated in the electrolytic solution. These reaction products may adsorb and deposit on the surface of the positive electrode or the negative electrode.

For example, on the negative electrode, cations of the ionic liquid may be reduced to produce a reduction product. The reduction product may further react with anions of the ionic liquid to produce by-products. In the possible adsorption state, the reduction product is adsorbed on the negative electrode surface together with the anions and/or the by-products with the anions are adsorbed on the negative electrode surface. As a result, when the surface of the negative electrode is analyzed by a surface analysis method such as XPS, elements derived from the ionic liquid are observed. For example, when the cation or anion of the ionic liquid contains F (fluorine), F is measured by XPS analysis. When the cation or anion of the ionic liquid contains B (boron), B is measured by XPS analysis.

When the atomic ratio R_{F} of F to C on the negative electrode surface calculated by the XPS method is 10% or more, the capacity due to the oxidation-reduction reaction remarkably increases, and a capacitor having a high capacity and a high energy density can be realized. More preferably, the ratio R_{F} may be 14% or more. The ratio R_{F} may be 14% or more. The ratio R_{F} may be less than or equal to 30%, or may be between 14% and 30% (inclusive).

The adsorption state formed on the surface of the negative electrode may include B. In that case, the atomic ratio R_{B} of B to C calculated by the XPS method may be 1% or more.

Specifically, for example, when 1-ethyl-3-methylimidazolium tetrafluoroborate (EMIBF₄), which is represented by the following Formula (1), is used as the ionic liquid, the 1-ethyl-3-methylimidazolium cation (EMI⁺) is reduced on the negative electrode during charge at a voltage of 4.0 V or more, and an EMI radical can be generated through the reaction represented by the following Formula (2).

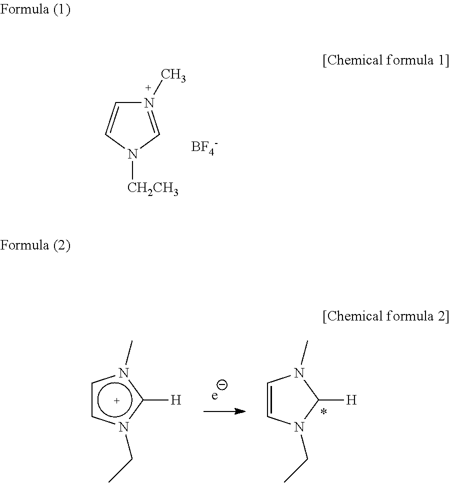

On the other hand, during discharge, the reverse reaction of the Formula (2) proceeds, and a reaction in which the EMI radical releases one electron and returns to the EMI⁺ cation (oxidation reaction) may proceed. Therefore, it is considered that the capacitor exhibits a capacity by adsorption of cations or anions and also exhibits an additional capacity through an oxidation-reduction reaction, thereby obtaining a remarkably high capacity, as a result.

The radical, which is the reaction product of the Formula (2), reacts with the anion BF₄⁻, and the reaction product can reach the negative electrode surface to form an adsorption state. The adsorbate includes F and B derived from BF₄⁻. When the adsorbent contains F or B such that the ratio R_{F} or the ratio R_{B} satisfies the above relationship formula, a high capacity and a high energy density can be achieved.

X-ray photoelectron spectroscopy (XPS) is a method of irradiating a sample surface with an X-ray and measuring the kinetic energy of photoelectrons generated by ionizing atoms and emitted from the sample surface to analyze the composition and the chemical bonding state of elements constituting the sample surface. In the XPS spectrum, the area of each peak is proportional to the number of atoms of the corresponding element. However, since the X-ray ionization cross section differs for each element and also depends on the setting of the device, it is not possible to compare peak areas corresponding to different elements to determine the composition ratio between the elements. Therefore, a sample whose composition is known is measured to determine in advance the relationship between the peak intensity and the number of atoms for each element. By using relative sensitivity factor (RSF), the composition of elements constituting the sample surface can be accurately quantified.

An example of conditions for XPS measurement will be described below. For calibration of the binding energy, the Cis spectrum of graphite (248.5 eV) can be used.

Measuring apparatus: ESCA5600 manufactured by ULVAC-PHI, Inc.
X-ray source used: Al-Kα ray, Mg-Kα ray
Analysis region: 800 μmΦ
Quantitative conversion method: The peak area of each element is multiplied by a relative sensitivity factor to obtain values, and the ratio of the obtained values is used to calculate quantitative values.

The first electrode and the second electrode may contain, for example, a fluorine-containing compound such as polyvinylidene fluoride (PVdF) or PTFE as a binder. In this case, in the XPS measurement of the electrode surface, as the peaks of the C element, peaks derived from C—F bonds derived from the binder contained in the electrode appear in addition to peaks derived from the ionic liquid. Since the peaks derived from C—F bonds derived from the binder appear at a position of binding energy different from that of the peaks derived from the ionic liquid, it is possible to determine from the peak position whether or not F present on the surface is derived from the ionic liquid. When the ratio R_{F} is determined, the number of atoms of the F element derived from the binder is subtracted from the number of atoms of the F element in the XPS spectrum to determine the number of atoms of the F element derived from the ionic liquid, and the subtracted value is divided by the number of atoms of the C element in the XPS spectrum to determine the ratio R_{F}.

It is considered that the ratio R_{F} (and the ratio R_{B}) depends on the type of anions and cations constituting the ionic liquid and the content (concentration) of the ionic liquid contained in the electrolytic solution, and also largely depends on the surface state of the first electrode (first active material) on which the adsorbent is deposited. In order to obtain a high capacity and a high energy density, it is important to select an active material capable of satisfying the above relationship of the ratio R_{F} (and the ratio R_{B}).

As the material of the first active material and/or the second active material, a carbon material having a layer structure can be used. That is, the carbon material includes a stacked structure of layers in each of which carbon atoms are bonded to form a hexagonal network in a plane (commonly referred to as graphene layer or graphene sheet). The carbon material may include graphene. The graphene may be a reduced graphene oxide or a graphene having a three-dimensional structure.

The graphene is a carbon material having, as a minimum unit, a graphene sheet having the thickness of one carbon atom, and usually constitutes a stacked body in which a plurality of graphene sheets are stacked. The graphene sheet is an aggregate or a molecule constituted by sp2-bonded carbon and having the thickness of one carbon atom, and has a honeycomb-like lattice structure spreading in a sheet shape.

At least the first active material of the first active material and the second active material may contain a carbon material having a layer structure.

The carbon material having a layer structure may be used as either an active material on the positive electrode side or an active material on the negative electrode side. However, in an exemplary embodiment, when an electrode containing the carbon material as the first active material is defined as the first electrode and used as the negative electrode, the ratio R_{F} and the ratio R_{B} are increased, and the capacity is dramatically increased.

The carbon material preferably contains a reduced graphene oxide. The reduced graphene oxide is obtained by reducing graphene oxide.

The graphene oxide (hereinafter, also referred to as “GO”) has a structure in which an oxygen-containing group is bonded to a graphene sheet. It is considered that the oxygen-containing group is mainly bonded to the edge surface of the graphene sheet stacked body. The oxygen-containing group is a hydrophilic group such as a hydroxyl group, a carbonyl group, a carboxyl group, or an epoxy group. The graphene oxide (GO) generally has dispersibility in a polar solvent such as water. The graphene oxide (GO), containing sp3-bonded carbon, generally has an insulating property.

When the graphene oxide (GO) is reduced, the oxygen-containing group is removed, and a reduced graphene oxide (hereinafter, also referred to as “rGO”) is obtained. The reduced graphene oxide (rGO) is a conductive graphene analog. The reduced graphene oxide may contain an oxygen-containing group that has not been removed in the reduction step. Due to functional groups such as an oxygen atom present in the graphene layer, the crystal structure of the carbon material deviates from the ideal graphene or graphite structure, and sp2 bonds and sp3 bonds are mixed in the carbon atoms in the graphene layer. As a result, the gap between the graphene layers is easily widened when applied with a high voltage, cations and anions are easily inserted between the graphene layers, and the region where the electric double layer is formed is easily enlarged. Therefore, the capacity of the capacitor can be dramatically increased by using the reduced graphene oxide as the active material.

In addition, due to functional groups such as an oxygen atom preset therein, distortion occurs in the planar structure of the graphene, and the layer structure has a disorder (or the inter-layer distance has a disorder), or the graphene layer is bent or flexed, thereby a three-dimensional structure can be formed. As a result, the effective surface area capable of adsorbing cations and anions is increased, and a high capacity can be realized. In addition, an adsorption state is easily formed through a reaction with the ionic liquid, and the ratios R_{F} and R_{B} are easily controlled to large values.

The general graphene usually has a flat sheet-like form. On the other hand, the graphene used in the capacitor of the exemplary embodiment does not need to have a flat sheet-like form, and may be a graphene sheet stacked body in various forms having a disorder in the layer structure (or a disorder in the inter-layer distance) (or having a three-dimensional structure). When the graphene having a three-dimensional structure (graphene sheet stacked body) is used as the active material, the capacity of the capacitor is dramatically increased.

The three-dimensional structure mainly means a microscopic three-dimensional structure (that is, a microstructure) formed in a flaky particle. By having a three-dimensional structure, overlap between graphene sheets is remarkably suppressed as compared with a flat sheet-shaped graphene, and the large surface area of graphene can be effectively utilized. On the principal surface of the graphene sheet stacked body having a three-dimensional structure (mainly 002 plane (basal plane)), a plurality of raised portions or a plurality of recessed portions (that is, lamella) are formed. With such a three-dimensional structure, the distance between the graphene sheets can be appropriately controlled, and overlap between the graphene sheets can be effectively reduced.

The three-dimensional structure may include a bent structure in which a graphene sheet having a lamella is flexed. One graphene sheet may be folded in the direction intersecting the plane of the sheet via the flexed portion to form a stacked body. The radius of curvature of the flexed portion in the bent structure is, for example, in a range of 10 nm to 1000 nm. The interval of the lamella is, for example, in a range of 10 nm to 100 nm.

The bent structure in the three-dimensional structure includes, for example, a crimped structure or a folded structure in the sheet portion between the flexed portions. At this time, each of the graphene sheet stacked bodies may have a microporous structure by itself. Therefore, ions more favorably diffuse in the vicinity of the surface of the stacked body. The presence of a crimped structure and a folded structure (that is, a lamella portion) can be confirmed in an electron microscope (SEM, TEM, etc.) photograph of the graphene sheet stacked body.

The crimped structure may be, for example, a structure having a plurality of randomly formed raised portions and recessed portions in a lamella shape. The folded structure is a structure having a folded portion in which one graphene sheet stacked body is partially folded a plurality of times, and is included in the category of the crimped structure. The height of the raised portion or the depth of the recessed portion, each of which is formed in the folded portion, may be larger than the thickness of the carbon portion of the graphene sheet stacked body having such a structure, or may be two times or more the thickness of the carbon portion.

The graphene having a three-dimensional structure may have a logarithmic differential pore distribution in which there is a peak in a pore size range of 2 nm to 4 nm, and the volume increases quadratically with the increase in pore size in a pore size range of 4 nm to 50 nm. The total mesopore volume in a pore size range of 2 nm to 50 nm may be, for example, 0.20 cm³/g or more. The total mesopore volume may be in a range of 0.20 cm³/g to 0.5 cm³/g, in a range of 0.25 cm³/g to 0.4 cm³/g, or in a range of 0.25 cm³/g to 0.35 cm³/g. The total of the pore volume within a pore size of 4 nm to 50 nm may be, for example, 15 times or more the total of the pore volume within a pore size of 2 nm to 4 nm.

The specific surface area and the pore size distribution of the graphene can be measured by using a BELSORP 28SA apparatus available from BEL JAPAN, Inc. As the analysis theory of mesopores, the Dollimore Heal method (DH method) is used, calculating based on the capillary condensation theory (Kelvin's equation).

The graphene having such a three-dimensional structure makes it possible to obtain a capacitor electrode whose logarithmic differential pore volume distribution measured using a mercury porosimeter has a maximum peak in a range between 0.3 m and 6 μm (inclusive). By having a three-dimensional structure, overlap between graphene sheets is remarkably suppressed as compared with a flat sheet-shaped graphene, and the surface area of the graphene can be effectively utilized for ion adsorption. With such a three-dimensional structure in which a plurality of raised portions or a plurality of recessed portions are formed on the basal plane, the distance between the graphene sheets can be appropriately controlled, and overlap between the graphene sheets can be effectively reduced. Therefore, the number of active sites of the active material can be increased without suppressing the movement (diffusion) of ions, and a high capacity can be exhibited.

The average number of stacked layers of the graphene sheet stacked body is, for example, less than or equal to 10, and may be less than or equal to 5. The nearer the graphene sheet stacked body is to the minimum unit graphene sheet having the thickness of one carbon atom (that is, monolayer sheet), the more preferable the graphene sheet stacked body is.

The average number of stacked layers is estimated from the inter-plane distance (d002) calculated from the diffraction peak attributed to the 002 plane (basal plane) in the X-ray diffraction profile (for example, the Physical Society of Japan 2015 Autumn Meeting, summary, p. 1014). Alternatively, the average number of stacked layers may be an estimated value obtained from an electron microscope (SEM or the like) photograph of the graphene. For example, the number of stacked graphene sheets can be estimated from the scale of the SEM photograph of the graphene and the inter-plane distance of the 002 plane (basal plane) of the graphene sheets. For example, 20 graphene sheet stacked bodies are arbitrarily selected, each of them is estimated for the number of stacked layers, the five values on the maximum side and the five values on the minimum side are removed, and the intermediate 10 values are averaged to determine the average number of stacked layers.

The inter-layer distance between the graphene sheets (that is, the distance between basal planes) may vary randomly. The randomly changed inter-layer distance means that the graphene sheet stacked body has low crystallinity. The larger the disorder of the stacked body structure of the stacked body is, the more remarkably the inter-layer distance changes.

The X-ray diffraction profile of the graphene usually has a diffraction peak attributed to the 002 plane. The diffraction peaks become sharp as overlap between the graphene sheets increases and the crystallinity of the graphene increases.

On the other hand, when the graphene has a three-dimensional structure, the diffraction peaks become broad, and the waveform can be separated into a plurality of peaks. On the higher angle side than the diffraction peaks, a halo pattern attributed to the amorphous phase may be observed.

The inter-plane distance d002 of the 002 plane of the graphene calculated from the X-ray diffraction profile is between 0.330 nm and 0.360 nm (inclusive). For d002, the diffraction peaks observed in the region around 2θ=26.38° is subjected to waveform separation, d002 is calculated for each component, and the average thereof is calculated. The distance d002 of the 002 plane of the graphene is preferably 0.340 nm (3.40 Å) or more, more preferably 0.360 nm (3.60 Å) or more, still more preferably 0.370 nm (3.70 Å) or more.

The electrolytic solution contains an ionic liquid. As the ionic liquid, a salt compound that exists in a liquid state at normal temperature (25° C.) and normal pressure (atmospheric pressure) can be preferably used. Examples of the cation constituting the salt compound include an imidazolium cation, a pyrrolidinium cation, a pyridinium cation, a piperidinium cation, an ammonium cation, and a phosphonium cation. Examples of the anion include a halide ion (Cl⁻, Br⁻, etc.), a tetrafluoroborate ion (BF₄⁻), a hexafluorophosphate ion (PF₆⁻), a bis(fluorosulfonyl) imide ion ((FSO₂)₂N⁻), and a bis(trifluoromethylsulfonyl) imide ion ((CF₃SO₂)₂N⁻).

Among these cations, a cation having a heteroaromatic ring can be used to realize an extremely high capacity. The reason for this is currently being clarified, but it is considered as the factors that the non-localized π orbit derived from the aromatic ring is likely to bond with the π orbit of the graphene to form a specifically stable adsorption state; the radical compound generated by a reduction reaction has a resonance structure and thereby can stably exist; and a stable adsorption state is easily formed together with the R orbit of the graphene.

When the anion includes a tetrafluoroborate ion (BF₄⁻), the binding energy may have a peak in a range of 686 to 692 eV in the F is spectrum in the XPS analysis of the negative electrode surface. Also when the anion includes a hexafluorophosphate ion (PF₆⁻), as in the case where the anion includes BF₄⁻, the binding energy may have a peak in a range of 686 to 692 eV in the FIs spectrum in the XPS analysis of the negative electrode surface. By analyzing the Bls spectrum and the Pls spectrum, it is possible to determine whether the anion includes BF₄⁻ or PF₆⁻(or both).

The cation having a heteroaromatic ring may be an imidazolium cation. The imidazolium cation may be a cation in which some hydrogen on the imidazole skeleton is substituted with an alkyl group or the like.

As an example of the imidazolium cation, the cation having a heteroaromatic ring may be a 1-C₁₋₃ alkyl-3-C₁₋₃ alkylimidazolium cation, and more specifically may include a 1-ethyl-3-methylimidazolium cation. Optionally, 80 mol % or more of the cation is a 1-C₁₋₃ alkyl-3-C₁₋₃ alkylimidazolium cation or a 1-ethyl-3-methylimidazolium cation.

In order to adjust the viscosity of the electrolytic solution and enhance the output characteristics, the ionic liquid may be mixed with a solvent to be used as the electrolytic solution. As the solvent, a solvent (non-aqueous solvent) conventionally used as an electrolytic solution of a capacitor can be used as long as it is uniformly mixed with the ionic liquid.

The non-aqueous solvent is preferably a high-boiling-point solvent. Examples of the solvent that can be used include lactones such as γ-butyrolactone, carbonates such as propylene carbonate, polyhydric alcohols such as ethylene glycol and propylene glycol, cyclic sulfones such as sulfolane, amides such as N-methylacetamide, N,N-dimethylformamide, and N-methyl-2-pyrrolidone, esters such as methyl acetate, ethers such as 1,4-dioxane, ketones such as methyl ethyl ketone, and formaldehyde.

When the electrolytic solution contains a solvent other than the ionic liquid, the proportion of the ionic liquid in the entire electrolytic solution may be 75 mass % or more, 80 mass % or more, or may be 90 mass % or more.

Using the graphene having the above structure as the active material, the first electrode and/or the second electrode is produced for a capacitor electrode. The capacitor electrode may contain a binder. When the graphene having a three-dimensional structure is formed into an electrode layer, the binder plays a role of assisting a bond between the graphenes and a bond between the graphene and the current collector.

Hereinafter, examples of the method for producing a graphene according to an exemplary embodiment of the present disclosure and the method for producing a capacitor electrode using the graphene produced thereby will be described.

### <<Method for Producing Graphene>>

### (i) Dispersion Preparation Step

First, an aqueous dispersion containing a graphene oxide is prepared. The aqueous dispersion may contain a dispersant such as carboxymethyl cellulose (CMC) and the like in addition to the graphene oxide and water. For example, the graphene oxide can be peeled and formed from graphite in a monolayer or multilayer state via oxidation of graphite.

Graphite can be oxidized, for example, using an oxidizing agent in water. Examples of the oxidizing agent to be used include sulfuric acid, potassium permanganate, chromic acid, sodium dichromate, sodium nitrate, a peroxide, a persulfate, and an organic peracid. Water may be added with a water-soluble solvent. Examples of the water-soluble solvent include an alcohol, a ketone such as acetone, and an ether such as dioxane and tetrahydrofuran. Through an oxidation reaction in water, an aqueous dispersion of the graphene oxide is produced.

The oxygen content of the graphene oxide may be, for example, 10 to 60 mass %, may be 20 to 50 mass %, or may be 30 to 50 mass %.

### (ii) Reduction Step

Next, the graphene oxide is reduced in the aqueous dispersion containing the graphene oxide to produce a reduced graphene oxide (first reduction step). As the reduction method, for example, hydrothermal treatment is preferable. For example, the aqueous dispersion may be sealed in an autoclave and subjected to hydrothermal treatment to produce a gel-like product. The temperature of the hydrothermal treatment may be, for example, 150° C. or higher, and preferably 170° C. or higher, and may be lower than or equal to 200° C.

Although it is possible to obtain a reduced graphene oxide having a three-dimensional structure only by the hydrothermal treatment, the gel-like product may be brought into contact with a reducing agent in order to further progress the reduction (second reduction step). Examples of the reducing agent include a metal hydride, a borohydride, a borane, hydrazine or a hydrazide, an ascorbic acid, a thioglycolic acid, a cysteine, a sulfurous acid, a thiosulfuric acid, and a dithionous acid. For example, the gel-like product may be immersed in an aqueous solution containing a water-soluble reducing agent such as sodium ascorbate. The temperature of the aqueous solution may be, for example, 20 to 110° C., may be 40 to 100° C., or may be 50 to 100° C. The amount of the reducing agent to be used may be appropriately adjusted according to the type of the reducing agent, the oxygen content of the first carbon raw material (graphene oxide), the amount of the gel-like product, and the like.

Thereafter, the gel-like product may be freeze-dried. By freeze-drying, a dry gel (xerogel) can be obtained in a state in which the three-dimensional structure of the graphene is highly maintained. The freeze-drying may be performed, for example, at −50° C. to 0° C., preferably at −50° C. to −2θ° C., under a reduced pressure of less than or equal to 100 Pa, more preferably less than or equal to 1 Pa.

Next, the dry gel is thermally reduced in a non-oxidizing atmosphere to desorb the residual functional groups (third reduction step).

The non-oxidizing atmosphere may be a decompressed atmosphere (for example, less than or equal to 0.1 MPa (preferably less than or equal to 10 Pa)), a reducing atmosphere (for example, a hydrogen atmosphere of less than or equal to 0.01 MPa), an inert gas atmosphere (for example, circulating atmosphere of N₂, Ar, Ne, He, or the like), or the like.

The heating temperature in the non-oxidizing atmosphere may be 700° C. or higher, may be 800° C. or higher, may be 900° C. or higher, may be 1000° C. or higher, or may be 1200° C. or higher. However, there is limitation in reducing the oxygen content of the reduced graphene oxide. Considering the production cost, the heating temperature in the non-oxidizing atmosphere may be lower than or equal to 1800° C., may be lower than or equal to 1400° C., or may be lower than or equal to 1200° C. When the temperature range is defined, these upper limit and lower limit may be arbitrarily combined. The temperature range may be, for example, 1000° C. to 1800° C.

The heating time in the non-oxidizing atmosphere is appropriately selected depending on the heating conditions and the amount of carbon to be treated, but may be, for example, about 0.1 to 5 hours.

The oxygen content of the dry gel after thermal reduction is less than 5 mass %, may be less than or equal to 4 mass %, less than or equal to 3 mass %, preferably less than 2.6 mass %, and may be less than or equal to 2 mass %, or 1.5 mass % or less. When the oxygen content is reduced to less than 5 mass %, the amount of the reactant generated by the oxidation-reduction reaction between the oxygen-containing group and the electrolytic solution component is reduced. Such a reactant blocks the pores of the electrode to reduce ion diffusivity, and reduces the number of ion adsorption sites. Therefore, as the amount of the reactant is smaller, the ion diffusivity is not reduced, and the number of ion adsorption sites is not reduced, so that a high capacity can be exhibited.

The dried gel after thermal reduction is pulverized to obtain a reduced graphene oxide powder (rGO powder).

By the above method, the graphene (reduced graphene oxide) having a three-dimensional structure is produced. By using the produced graphene, for example, a capacitor electrode can be produced by the following method.

### Method for Producing Capacitor Electrode

(iii) Electrode Formation Step

For example, the rGO powder is dispersed in a dispersion medium such as water together with the binder to prepare a slurry. The obtained slurry is applied onto a conductive base material (current collector), and the coating film is dried to form an electrode layer supported on the current collector, thereby obtaining a capacitor electrode. Thereafter, the electrode layer may be rolled.

Examples of the binder to be used include a fluororesin such as polytetrafluoroethylene (PTFE), polyvinylidene fluoride (PVdF), and a vinylidene fluoride-hexafluoropropylene copolymer (PVdF-HFP); and a water-soluble resin such as carboxymethyl cellulose (CMC), polyethylene oxide (PEO), polyethylene glycol (PEG), polyacrylonitrile (PAN), polymethyl methacrylate (PMMA), polyvinyl alcohol (PVA), polyvinyl pyrrolidone (PVP), polyacrylic acid (PAA), and polyvinyl acetate.

The electrode layer may contain another active material such as activated carbon in addition to the graphene. The electrode layer may contain a carbon fiber such as carbon nanotube (CNT), and a carbon particle such as carbon black and graphite. However, from the viewpoint of achieving both high capacity and high reliability, the graphene preferably constitutes 50 mass % or more of the electrode layer, and more preferably constitutes 65 mass % or more thereof.

As the current collector, a metal foil, a metal porous body, or the like can be used. As the material of the current collector, aluminum, copper, nickel, iron, stainless steel, platinum, or the like may be used. An alloy containing these metals as a main component may be used. The metal foil may be a plain foil, or may be a foil roughened by etching or the like, a foil subjected to plasma treatment, or the like. The metal porous body has, for example, a three-dimensional network structure.

The mass of the metal porous body per unit area may be, for example, less than or equal to 500 g/m², or less than or equal to 150 g/m². The porosity of the metal porous body may be, for example, 80 vol % to 98 vol %, and may be 90 vol % to 98 vol %.

The average pore size of the voids of the metal porous body may be, for example, between 50 μm and 1000 μm (inclusive), may be between 400 μm and 900 μm (inclusive), or may be between 450 μm and 850 μm (inclusive).

### <<Capacitor>>

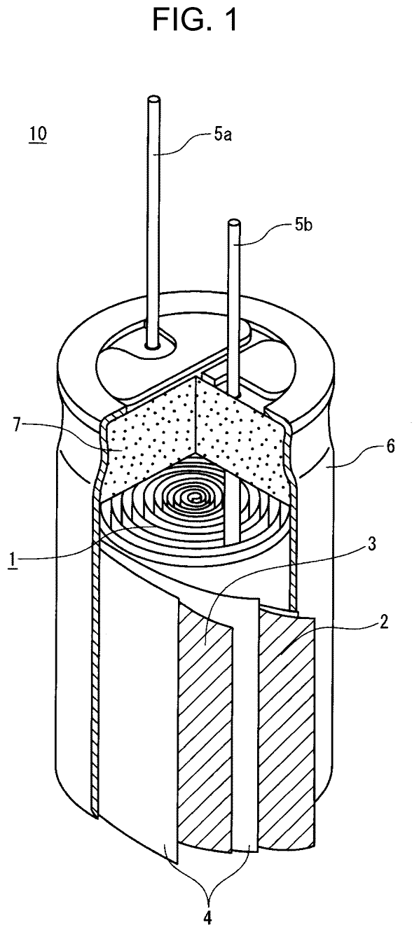

Next, an example of the electrochemical capacitor including the above capacitor electrodes as the first electrode and the second electrode will be described. FIG. 1 is a partially cutaway perspective view of capacitor 10.

Capacitor 10 in the illustrated example includes wound capacitor element 1. Capacitor element 1 has a structure in which sheet-like first electrode 2 and sheet-like second electrode 3 are wound with separator 4 interposed therebetween. First electrode 2 and second electrode 3 have a first current collector and a second current collector made of metal, and a first electrode layer and a second electrode layer supported on the surface thereof, respectively, and exhibit a capacity by adsorbing and desorbing ions. For example, an aluminum foil is used as the first and second current collectors. The surface of the current collector may be roughened by a method such as etching. Lead wires 5a and 5b are connected as lead-out members to first electrode 2 and second electrode 3, respectively. Capacitor element 1 is housed in cylindrical outer case 6 together with an electrolytic solution (not shown). The material of outer case 6 may be, for example, metal such as aluminum, stainless steel, copper, iron, or brass. The opening of outer case 6 is sealed with sealing member 7. Lead wires 5a and 5b penetrate sealing member 7 and are led out to the outside. For sealing member 7, for example, a rubber material such as butyl rubber is used.

The electrode layer contains an active material as an essential component, and may contain a binder, a conductive aid, and the like as an optional component. The active material includes, for example, the graphene having the characteristics described above. The electrode layer is obtained, for example, as follows: an active material, a binder (for example, carboxymethylcellulose (CMC)), and the like are kneaded together with water with a kneader to obtain a slurry; the slurry is applied on the surface of a current collector; and the coating film is dried and rolled.

The separator preferably contains cellulose or a derivative thereof. Cellulose is stable against both acid and alkali, and is stable even in an environment where a high voltage is applied. In addition, cellulose has a large tensile strength, and has sufficient strength even when the first electrode and the second electrode are wound to form a winding-type electrode group. Regarding the form of the separator, for example, a microporous membrane, a woven fabric, a nonwoven fabric, or the like can be used. The thickness of the separator is, for example, 8 μm to 50 μm, preferably 12 μm to 35 μm, and more preferably 14 μm to 35 μm, or 16 μm to 35 μm.

In the above exemplary embodiment, the wound capacitor has been described, but the application range of the present invention is not limited to the above. The present invention can also be applied to a capacitor having another structure, for example, a stacked capacitor or a coin capacitor.

Hereinafter, the present invention will be described in more detail based on examples, but the present invention is not limited to the examples.

### Example 1

### (1) Preparation of Capacitor Electrode

Graphite was oxidized in water using potassium permanganate as an oxidizing agent to obtain a graphene oxide. The aqueous dispersion containing 1 mass % of the graphene oxide was subjected to hydrothermal treatment at 180° C. for 6 hours to obtain a gel-like product (first reduction step).

Subsequently, the gel-like product was immersed in an aqueous sodium ascorbate solution (sodium ascorbate concentration: 1.0 mol/L) as a reducing agent, heated to 100° C., and held for 2 hours to sufficiently reduce the carbon (second reduction step).

Thereafter, the gel-like product was freeze-dried at −20° C. under a reduced pressure of 100 Pa to obtain a xerogel. Subsequently, the xerogel was then heat-treated by heating at 1200° C. for 2 hours under nitrogen flow (third reduction step). The heat-treated xerogel was pulverized to obtain a reduced graphene oxide powder.

Then 100 parts by mass of the reduced graphene oxide powder and 10 parts by mass of CMC as a binder were dispersed in an appropriate amount of water to prepare a slurry. The obtained slurry was applied onto a current collector made of an Al foil and having a thickness of 30 μm, and the coating film was vacuum-dried at 110° C. and rolled to form an electrode layer, thereby obtaining a capacitor electrode.

### (2) Preparation of Capacitor

A pair of capacitor electrodes was prepared and punched into a square shape of 20 mm×20 mm. Each of the capacitor electrodes was connected to a lead wire, and the capacitor electrodes were overlapped with each other such that the coated surfaces of each electrode layer faced each other with a separator made of cellulose nonwoven fabric interposed therebetween, thereby obtaining a stacked capacitor element. The capacitor element was housed in an Al-laminated outer case together with an electrolytic solution, and sealed with a sealing member to complete capacitor Al of Example 1. Thereafter, an aging treatment was performed at 60° C. for 6 hours while 2.5 V was applied.

As the electrolytic solution for capacitor Al, 1-ethyl-3-methylimidazolium tetrafluoroborate (EMIBF₄) as an ionic liquid was used.

### Comparative Example 1

A physically peeled graphene, obtained by physically peeling graphite, was prepared. A capacitor electrode was produced using the physically peeled graphene as an active material instead of the reduced graphene oxide in Example 1, and a capacitor element was obtained using the capacitor electrode.

Except for the above, capacitor B1 of Comparative Example 1 was produced in the same manner as in Example 1.

Capacitors A1 and B1 were evaluated as described below.

### <Evaluation>

The capacity of each of capacitors A1 and B1 was evaluated by the following method.

The produced capacitor was charged at constant current to set voltage V₁ (=2.8 V) at a current of 0.1 to 1 Å/g with respect to the weight of the cell active material (the total of the mass of the positive electrode active material and the mass of the negative electrode active material). Thereafter, constant voltage charge was performed at set voltage V₁ for 8 minutes.

After completion of the constant voltage charge, constant current discharge was performed to 0 V at a current of 0.1 to 1 Å/g with respect to the weight of the cell active material. The capacity was calculated from the slope of voltage change until the voltage decreased from 2.1 V to 0.1 V during discharge. The capacity is calculated by the following equation, where the constant current value during discharge is I (A), and the discharge time until the voltage decreases from 2.1 V to 0.1 V is t (sec).

Capacity (F)=It/(2.1−0.1)

From the calculated capacity, the single electrode capacity was calculated assuming that the capacity of the positive electrode and the capacity of the negative electrode (the mass of the positive electrode active material and the mass of the negative electrode active material) are equal to each other, and single electrode capacity C₁ (F/g) per 1 g of the positive or negative electrode active material was determined when voltage V₁ was applied.

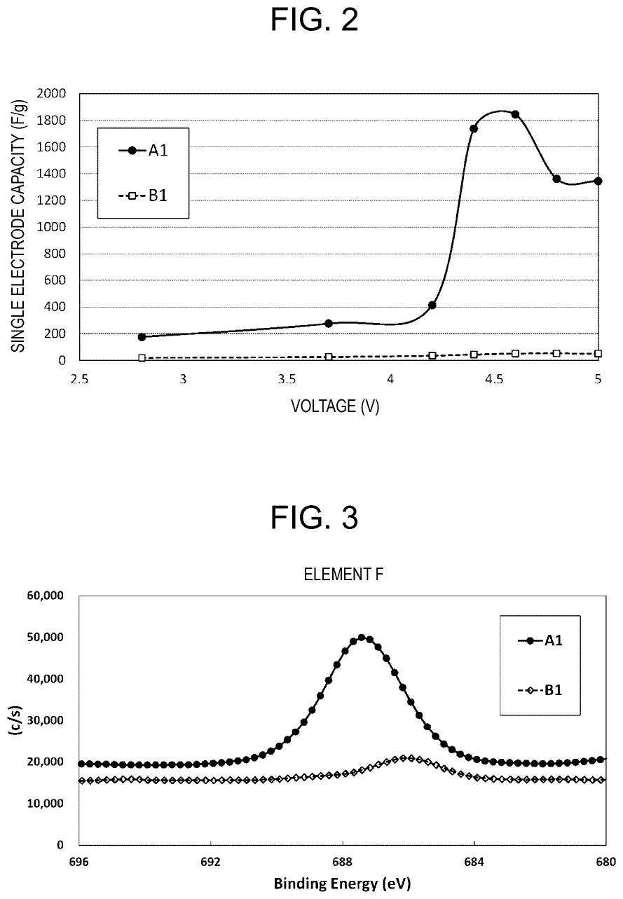

Changing set voltage V₁ from 2.8 V to 5.0 V, single electrode capacity C₁ (F/g) per 1 g of the positive or negative electrode active material was determined in the same manner as described above, and the dependency of single electrode capacity C₁ against voltage V₁ was evaluated. The results are shown in the graph of FIG. 2.

Further, after the charge was completed at V₁=4.4 V, the negative electrode was removed from the capacitor. The removed negative electrode was washed with dimethyl carbonate and then dried. The surface of the dried negative electrode was subjected to XPS quantitative analysis to determine the ratios R_{F} and R_{B} by the above-described method. The results are shown in Table 1.

TABLE 1

| Capacitor | R_{F} (%) | R_{B} (%) |
|---|---|---|
| A1 | 19.8 | 1.4 |
| B1 | 3.0 | 0.8 |

From the graph of FIG. 2, capacitor A1 had single electrode capacity C₁ sharply increased as voltage V₁ applied to the capacitor was increased to 4.0 V or more. On the other hand, capacitor B1 had single electrode capacity C₁ smaller than that of capacitor A1, and single electrode capacity C₁ was slightly increased even when voltage V₁ applied to the capacitor was increased to 4.0 V or more.

As can be seen from Table 1, in capacitor A1, the ratio R_{F}, which is the ratio of F present on the surface of the negative electrode with respect to C, is as large as 10% or more, and the ratio R_{B}, which is the ratio of B with respect to C, is also as large as 1% or more. It is found that there is a capacity increase due to the oxidation-reduction reaction. On the other hand, in capacitor B1, both the ratio R_{F} and the ratio R_{B} are small. In capacitor B1, B and F are present only in a small amount on the surface of the negative electrode. It is found that there is no capacity increase due to the oxidation-reduction reaction.

FIG. 3 shows F1s spectra of the surface of a negative electrode in XPS analysis for capacitors A1 and B1. In both capacitors A1 and B1, a peak is observed in the F1s spectrum. However, the peak of capacitor B1 is smaller than that of capacitor A1, and the peak position is different. This is presumably because: in capacitor B1, the peak appearing in the F1s spectrum is a peak derived from BF₄⁻ present in the vicinity of the negative electrode surface, whereas in capacitor A1, the peak appearing in the F1s spectrum is due to by-products that are generated after the EMI⁺ cation is reduced to be a reaction product, and the reaction product further reacts with BF₄⁻; and there is a difference in the bonding state of F.

### INDUSTRIAL APPLICABILITY

According to the present invention, an electrochemical capacitor having a high energy density can be obtained.

### REFERENCE MARKS IN THE DRAWINGS

1 capacitor element
2 first electrode
3 second electrode
4 separator
5a first lead wire
5b second lead wire
6 outer case
7 sealing member
10 capacitor

1. An electrochemical capacitor comprising:
a first electrode containing a first active material;
a second electrode containing a second active material; and
an electrolytic solution, wherein
the electrolytic solution contains an ionic liquid, and
when a surface of the first electrode is quantitatively analyzed based on relative sensitivity factor by using X-ray photoelectron spectroscopy (XPS), an atomic ratio R_{F} of an element F derived from the ionic liquid to an element C is 10% or more.

2. The electrochemical capacitor according to claim 1, wherein the atomic ratio R_{F} is 14% or more.

3. The electrochemical capacitor according to claim 1, wherein, when the surface of the first electrode is quantitatively analyzed based on relative sensitivity factor by using X-ray photoelectron spectroscopy (XPS), an atomic ratio R_{B} of an element B to an element C is 1% or more.

4. The electrochemical capacitor according to claim 1, wherein the first electrode is applied with a lower potential than the second electrode.

5. The electrochemical capacitor according to claim 4, wherein a voltage of 4.0 V or more is applied between the first electrode and the second electrode.

6. The electrochemical capacitor according to claim 1, wherein the first active material contains a reduced graphene oxide.

7. The electrochemical capacitor according to claim 1, wherein the ionic liquid contains a cation having a heteroaromatic ring.

8. The electrochemical capacitor according to claim 7, wherein the cation includes a 1-ethyl-3-methylimidazolium cation.

9. The electrochemical capacitor according to claim 1, wherein the ionic liquid contains a tetrafluoroborate anion.
